(19) United States
(12) Patent Application Publication
(10) Pub. No.: US 2010/0050513 A1
(43) Pub. Date: Mar. 4, 2010

(54) Methods of growing aquatic flora

(76) Inventor: Gerald J. Grott, Phoenix, AZ (US)

Correspondence Address: THE LUTHER LAW FIRM, PLC, 10575 N 114TH STREET, SUITE 103, SCOTTSDALE, AZ, 85259, US

(21) Appl. No.: 12/231,129

(22) Filed: Aug. 29, 2008

(51) Int. Cl. A01G 31/00

(52) U.S. Cl. 47/59 R

(57) ABSTRACT

A method of growing rooted plants and non-rooted aquatic organisms in a pond. Rooted aquatic plants are planted spaced apart and non-rooted aquatic organisms, such as floating plants or algae, are grown in the space between the rooted plants.

### FIELD OF THE INVENTION

This invention relates to methods of growing aquatic flora, such as submergent and mergent macrophytes (rooted aquatic plants) and free-floating macrophytes and algae.

More particularly, the invention pertains to methods for growing rootless flora such as floating non-rooted plants (free floating macrophytes) and algaes along with submergent and mergent rooted aquatic plants.

### BACKGROUND OF THE INVENTION

Rooted aquatic plants and rootless organisms such as floating plants and algae are seen as an important source of high-protein animal foods, intermediates in producing human foods, synthetic fuels, etc.

It is known to grow rootless aquatic organisms floating in water, such as algae and floating plants, in comparatively small flats or containers or in narrow beds or channels. The size and shape of these growing containers or beds are selected to reduce the tendency of the rootless organisms to pile up, agglomerate or be submerged by wind action or water currents. Such agglomeration or submersion reduces the access of the organisms to the ambient atmosphere, from which they absorb CO₂, and reduces their access to sunlight, both necessary for photosynthesis, ultimately detracting from the production rates and, consequently, the economics of production.

The small size of these containers or narrow growing beds detracts seriously from the economics of producing such rootless organisms for use as animal feeds, intermediates in producing human foods, synthetic fuels, etc. Because both the absorption of CO₂, from the ambient atmosphere and the absorption of radiant energy are proportional to the surface area of the growing beds, using small or narrow beds or containers raises the capital cost of growing the rootless organisms and reduces overall production rates per unit area of the growing facility, raising the cost of constructing, operating and maintaining the facility.

### BRIEF DESCRIPTION OF THE INVENTION

I have now discovered growing methods which improve the economics of growing aquatic flora. As an additional benefit, I can make use of waters which are otherwise considered waste, disposal of which can be cumbersome and costly.

According to my invention, I provide a method of growing rooted and non-rooted aquatic organisms in a pond. My method comprises the steps of growing rooted aquatic plants, planted spaced apart in eutrophic ponds and growing non-rooted aquatic organisms between the rooted plants. The distance between the spaced rooted plants is selected to be large enough to allow growth of the rooted plants, but small enough to reduce the tendency of the non-rooted organisms to agglomerate or be submerged, which reduces access of the non-rooted organisms to ambient air and sunlight.

### DEFINITIONS

As used herein:
“Pond” means an expanse of shallow aqueous medium confined by suitable berms or walls;
“Rooted aquatic plant” means a plant that is secured in a fixed transverse location by its roots embedded in the bottom of the pond, with the top portions of the plant (stalk, leaves, etc.) extending above the surface of the water.
“Non-rooted aquatic organisms” means either non-rooted aquatic plants or algaes, or both;

### DESCRIPTION OF THE PRESENTLY PREFERRED EMBODIMENTS

The aqueous medium employed can be fresh or saline water, containing dissolved metal salts and, optionally, including added fertilizer components. I presently prefer to employ salty waters such as seawater, agricultural runoff, petroleum production brines, salty aquifer waters, and the like, especially waters that would otherwise be considered waste because of salinity, disposal of which can be costly and cumbersome.

The rooted aquatic plants I employ can be any of a wide variety of plants with appropriate structure and with tolerance for the particular aqueous medium to be employed. For example, if the aqueous medium is seawater or other salty water, I select from among rooted salt-tolerant aquatic plants (halophytes) such as Distichlis spicata (salt grass), Phyliospadix (surf grass) or salicornias such as Long-stalked Glassworts (Salicornia dolichostachya) American, Virginia or Woody Glasswort (Salicornia virginica). Common Glasswort (Salicornia europea), Slender Glasswort (Salicornia maritima), Perennial Glasswort (Salicornia perennis), Purple Glasswort (Salicornia ramosissima), and Umari Keerai, (Salicornia brachiata). For fresh-water or slightly salty aqueous medium, I employ rice or Distichlis spicata stricta as the rooted aquatic plant, which grows well in waters with up to 1.5% salt.

The non-rooted aquatic organisms I employ can be selected from a wide variety of those which have tolerance for the particular aqueous medium to be employed. For example, if the aqueous medium is seawater or other salty water, I select from among salt-tolerant floating aquatic plants such as bladderwort, common duckweed, common salvinia, giant duckweed, giant salvinia, mosquito fern, water hyacinth, water lettuce and watermeal and algaes such as Enteromorpha clathrata, psilosiphon and Caloglossa.

A stand of spaced rooted plants is established by manual or mechanized transplanting of seedlings, or by broadcast sowing of seeds, followed by thinning to the desired spacing, as in rice production or by viviparous reproduction.

The crop of non-rooted organisms is established between the rooted organisms by distributing fragments of the organism between the rooted plants, where it grows by asexual reproduction.

The distance between the spaced rooted plants is selected to be large enough to allow growth of the rooted plants, but small enough to reduce the tendency of the non-rooted organisms to agglomerate or be submerged which reduces access of the non-rooted organisms to the ambient atmosphere and sunlight. The rooted plants can be spaced uniformly apart from each other or can be planted and grown in parallel rows with growing space for the non-rooted plants between the rows.

In the preferred embodiment, I plant the rooted plants closely together, but in intersecting rows, forming barriers defining open areas for growing the non-rooted organisms, i.e., in the spaces defined by the intersecting walls of the rooted plants. In all cases, the exact spacings are determined by routine experiments by those skilled in the art, to provide maximum yield and production rate of the non-rooted organisms under the prevailing winds, water currents and sunlight angles of the particular growing installation.

For example, in Gila County, Arizona, growing enteromorpha clathra algae in salty irrigation drainage water is facilitated by spacing hills of rooted plants such as salt grass apart, in intersecting rows defining substantially oblong growing spaces for the algae about three feet long by one foot wide, with the long axes of the growing spaces perpendicular to the prevailing Southwest wind direction. Care is taken to introduce and drain the salty irrigation drainage water used in the beds without causing transverse currents, such as by introducing fresh drainage water upwardly from perforated pipes located under in the rows of intersecting rooted plants and the water is withdrawn from the beds downwardly into drain tiles located under the algae growing beds. This tends to keep the algae from collecting and agglomerating at the rooted plants.

Having described my invention in such terms as to enable one skilled in the art to understand and practice it and having identified the presently preferred embodiments thereof, I claim:

1. A method of growing rooted plants and non-rooted aquatic organisms in a pond,: comprising the steps of:
(a) growing rooted aquatic plants, planted spaced apart in said pond; and
(b) growing non-rooted aquatic organisms between said rooted plants; the distance between said spaced rooted plants being selected to be large enough to allow growth of said rooted plants, but small enough to reduce the tendency of said non-rooted organisms to agglomerate or be submerged, depriving them of sunlight and access to the ambient atmosphere.
